(19) United States
(12) Patent Application Publication
(10) Pub. No.: US 2023/0369615 A1
(43) Pub. Date: Nov. 16, 2023

(54) FUEL CELL STACK

(71) Applicant: TOYOTA JIDOSHA KABUSHIKI KAISHA, Toyota-shi (JP)

(72) Inventor: Naoki TAKEHIRO, Sunto-gun (JP)

(73) Assignee: TOYOTA JIDOSHA KABUSHIKI KAISHA, Toyota-shi (JP)

(21) Appl. No.: 18/298,559

(22) Filed: Apr. 11, 2023

(30) Foreign Application Priority Data
May 16, 2022 (JP) 2022-079940

(51) Int. Cl. H01M 8/0258; H01M 8/2483; H01M 8/0267; H01M 8/0208

(52) U.S. Cl. CPC H01M 8/0258; H01M 8/2483; H01M 8/0267; H01M 8/0208

(57) ABSTRACT

In a fuel cell stack, a separator includes, in a region adjacent to a coolant manifold of the unit cell in a planar direction, a sacrificial electrolytic corrosion region that is not adhered to an insulating sheet adjacent in a laminating direction, and a sealing region that is adjacent to the sacrificial electrolytic corrosion region in the planar direction and is adhered to the insulating sheet. The sacrificial electrolytic corrosion region includes a coolant lead-in or lead-out region and a region other than the coolant lead-in or lead-out region. A shape of the separator in the coolant lead-in or lead-out region is a flat plate shape that is in contact with the insulating sheet, and a shape of the separator in the region other than the coolant lead-in or lead-out region of is an uneven shape that is at least partially out of contact with the insulating sheet.

### CROSS-REFERENCE TO RELATED APPLICATION

This application claims priority to Japanese Patent Application No. 2022-079940 filed on May 16, 2022, incorporated herein by reference in its entirety.

### BACKGROUND

### 1. Technical Field

The present disclosure relates to a fuel cell stack.

### 2. Description of Related Art

Various studies have been made on fuel cells.

For example, Japanese Patent No. 4901169 discloses technology of separately providing a sacrificial member to deal with electrolytic corrosion that occurs in a coolant manifold by the sacrificial member.
For example, Japanese Unexamined Patent Application Publication No. 2016-096033 (JP 2016-096033 A) discloses a fuel cell stack capable of suppressing occurrence of corrosion of a separator.
For example, Japanese Unexamined Patent Application Publication No. 2008-016216 (JP 2008-016216 A) discloses a fuel cell system that effectively suppresses corrosion of a separator and so forth, particularly on a high potential side.
For example, Japanese Unexamined Patent Application Publication No. 2010-113864 (JP 2010-113864 A) discloses a fuel cell having a mechanism for suppressing corrosion of a separator plate due to coolant that recovers heat from the fuel cell.
For example, Japanese Unexamined Patent Application Publication No. 2010-113863 (JP 2010-113863 A) discloses a fuel cell having a mechanism for suppressing corrosion of fuel cell stack components, such as a conductive separator, by a coolant that recovers heat from the fuel cell.

### SUMMARY

In a coolant lead-in or lead-out region of a coolant manifold of a fuel cell stack, particularly on an outlet side thereof, high-temperature coolant flows out, and accordingly ionic conductivity of the coolant increases, ionic resistance of the coolant decreases, and electrolytic corrosion becomes concentrated, shortening the life of the fuel cell stack.

A sacrificial member is separately provided to deal with electrolytic corrosion that occurs in the coolant manifold by the sacrificial member, and accordingly the number of parts making up the fuel cell stack increases, thereby raising the cost of the fuel cell stack.
Also, with respect to electrolytic corrosion that occurs in the coolant manifold, changing the separator base material of the cell at which electrolytic corrosion occurs from an inexpensive stainless steel material such as steel-use-stainless to a highly corrosion-resistant material such as titanium raises the cost of the fuel cell stack.

The present disclosure provides a fuel cell stack that can have a long life with an inexpensive configuration.

One aspect of the present disclosure provides a fuel cell stack. The fuel cell stack has a cell stack in which multiple unit cells are stacked together, each of the unit cells including a separator made of stainless steel.

The unit cell includes a cathode separator, an anode separator, and an insulating sheet disposed between the cathode separator and the anode separator.
In at least one unit cell among the unit cells, at least one separator out of the cathode separator and the anode separator includes, in a region adjacent to a coolant manifold of the unit cell in a planar direction, a sacrificial electrolytic corrosion region that is not adhered to the insulating sheet adjacent in a laminating direction, and a sealing region that is adjacent to the sacrificial electrolytic corrosion region in the planar direction and is adhered to the insulating sheet.
The sacrificial electrolytic corrosion region includes a coolant lead-in or lead-out region and a region other than the coolant lead-in or lead-out region. A shape of the separator in the coolant lead-in or lead-out region is a flat plate shape that is in contact with the insulating sheet, and a shape of the separator in the region other than the coolant lead-in or lead-out region of the separator is an uneven shape that is at least partially out of contact with the insulating sheet.

In the fuel cell stack according to the above aspect, when a width of the sacrificial electrolytic corrosion region in the planar direction, from an end portion of the coolant manifold on a coolant inlet or outlet side, is defined as a sacrificial electrolytic corrosion distance W, a sacrificial electrolytic corrosion surface area W x D that is a product of the sacrificial electrolytic corrosion distance W and a thickness D of the separator, may be 0.25 mm² or more,

In the fuel cell stack according to the above aspect, at least one type of separator may include a sacrificial electrolytic corrosion region protruding portion that protrudes further in the planar direction toward a partial region of the coolant manifold than the insulating sheet adjacent to the separator, the type of separator being selected from a group consisting of a cathode separator of a highest-potential unit cell that contributes to power generation and has the highest electrical potential among the unit cells, a cathode separator of an end portion unit cell that is adjacent to the highest-potential unit cell and does not contribute to power generation, and an anode separator of the end portion unit cell,.

In the fuel cell stack according to the above aspect, the cathode separator of the highest-potential unit cell may include the sacrificial electrolytic corrosion region protruding portion.

In the fuel cell stack according to the above aspect, the sacrificial electrolytic corrosion distance W may be 2.1 mm to 13 mm, and the thickness D of the separator may be 0.08 mm to 0.12 mm.

The fuel cell stack of the present disclosure can have a long life with an inexpensive configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an example of a vicinity of a coolant discharge manifold of a fuel cell stack according to a first embodiment of the present disclosure;

FIG. 2 is a schematic cross-sectional view illustrating an example for describing a sacrificial electrolytic corrosion distance W and a separator thickness D of a fuel cell stack according to a second embodiment of the present disclosure, in a vicinity of a coolant discharge manifold;

FIG. 3 is a graph showing an example of a relation between the sacrificial electrolytic corrosion distance W of separators having different ionic conductivities in the fuel cell stack according to the second embodiment of the present disclosure, and the life of the fuel cell stack; and

FIG. 4 is a schematic cross-sectional view illustrating an example of a vicinity of a coolant discharge manifold of a fuel cell stack according to a third embodiment of the present disclosure.

### DETAILED DESCRIPTION OF EMBODIMENTS

Embodiments according to the present disclosure will be described below. Note that matters other than those stated in particular in the present specification but necessary to carry out the present disclosure (e.g., general configurations and manufacturing processes of fuel cell stacks, which are not features of the present disclosure) can be understood to be matters of design of those skilled in the art based on the related art in this field. The present disclosure can be implemented based on the content disclosed in this specification and common general technical knowledge in the field.

Also, dimensional relations (length, width, thickness, etc.) in the drawings do not reflect actual dimensional relations.
In the present specification, the term “to” used to indicate a numerical range is used in the sense of including the numerical values described before and thereafter as a lower limit value and an upper limit value.
Any combination of the upper limit value and the lower limit value in the numerical range can be adopted.

The present disclosure provides a fuel cell stack that has a cell stack in which multiple unit cells, each having separators made of stainless steel, are stacked together. The unit cells each include a cathode separator, an anode separator, and an insulating sheet disposed between the cathode separator and the anode separator.

In at least one unit cell among the unit cells, at least one separator out of the cathode separator and the anode separator includes, in a region adjacent to a coolant manifold of the unit cell in a planar direction, a sacrificial electrolytic corrosion region that is not adhered to the insulating sheet adjacent in a laminating direction, and a sealing region that is adjacent to the sacrificial electrolytic corrosion region in the planar direction and is adhered to the insulating sheet.
In the sacrificial electrolytic corrosion region, a shape of a coolant lead-in or lead-out region of the separator is a flat plate shape that is in contact with the insulating sheet, and the shape of the region other than the coolant lead-in or lead-out region of the separator in the sacrificial electrolytic corrosion region may be an uneven shape that is at least partially out of contact with the insulating sheet.

In the present disclosure, in a cell in which electrolytic corrosion occurs, a predetermined region from an end portion of the coolant manifold is defined as a sacrificial electrolytic corrosion region, using an inexpensive stainless steel material, and a sealing region is set outside that region.

In the present disclosure, a coolant manifold of a fuel cell in which stainless steel separators are used has a sacrificial electrolytic corrosion region, and a separator is flat-plated in a coolant lead-in or lead-out region of the sacrificial electrolytic corrosion region and only one face thereof is in contact with the coolant. Meanwhile, the separator in a region other than those at the coolant lead-in or lead-out region of the sacrificial electrolytic corrosion region has an uneven shape, has a region that does not come into contact with the insulating sheet, and has a structure in which both faces of the separator are in contact with the coolant during electrolytic corrosion. The electrolytic corrosion reaction in the sacrificial electrolytic corrosion region is further promoted by increasing the surface area, by providing the surface with unevenness.
According to the present disclosure, electrolytic corrosion occurs on both faces of the separator in the region of the sacrificial electrolytic corrosion region that is not in contact with the insulating sheet, thus promoting the electrolytic corrosion reaction. Accordingly, the effects of sacrificial electrolytic corrosion at this portion are increased, and the concentration of electrolytic corrosion at the coolant lead-in or lead-out region is reduced, whereby the life of the fuel cell stack can be extended. Also, a stainless steel separator can be used to realize an inexpensive configuration.

The fuel cell stack according to the present disclosure has a cell stack in which multiple unit cells, each having separators made of stainless steel, are stacked together. In the present disclosure, both the unit cell and the fuel cell stack in which unit cells are stacked together may be referred to as the fuel cell.

A unit cell may be referred to as a cell in the present disclosure.

A cell stack is a stack obtained by stacking the unit cells together.

The number of unit cells stacked in the cell stack is not limited in particular, and may be from two to several hundred.
A fastening load may be applied to the cell stack by a fastening member.
Examples of fastening members include shaft members such as bolts with threads on both ends and nuts, spring members, and so forth.
The fuel cell stack may have a pair of end plates at both ends in the stacking direction of the cell stack.
Examples of fastening the cell stack include a method of applying a fastening load by screw fastening via the end plates disposed at both ends of the cell stack in the stacking direction, using shaft members such as bolts with threads on both ends and nuts, and so forth, and a method of applying a fastening load by using a spring member, and so forth.

A unit cell of a fuel cell includes a cathode separator, an anode separator, and an insulating sheet disposed between the cathode separator and the anode separator, typically including a membrane electrode gas diffusion layer assembly (MEGA). The membrane electrode gas diffusion layer assembly has an anode-side gas diffusion layer, an anode catalyst layer, an electrolyte membrane, a cathode catalyst layer, and a cathode-side gas diffusion layer, in this order.

A cathode (oxidant electrode) includes the cathode catalyst layer and the cathode-side gas diffusion layer.

An anode (fuel electrode) includes the anode catalyst layer and the anode-side gas diffusion layer.
The cathode catalyst layer and the anode catalyst layer will be collectively referred to as “catalyst layers”.
For example, the catalyst layer may include a catalyst metal that promotes electrochemical reaction, an electrolyte having proton conductivity, a support having electron conductivity, and so forth.
Examples of the catalyst metal include platinum (Pt), alloys made of Pt and another metal (e.g., a Pt alloy including cobalt, nickel, or the like), and so forth.
The electrolyte may be a fluororesin or the like. Examples of the fluororesin that may be used include a Nafion solution and so forth.
The catalyst metal is supported on a support, and in each catalyst layer, the support that supports the catalyst metal (catalyst support) may be intermingled with the electrolyte.
Examples of the support that supports the catalyst metal include carbon materials such as commercially-available carbon, and so forth.

The cathode-side gas diffusion layer and the anode-side gas diffusion layer will be collectively referred to as “gas diffusion layers”.

The diffusion layers may be an electroconductive member or the like having gas permeability.
Examples of the electroconductive member include a carbon porous body such as carbon cloth, carbon paper, or the like, and a porous metal such as a metal mesh, a foamed metal, or the like.

The electrolyte membrane may be a solid polymer electrolyte membrane. Examples of the solid polymer electrolyte membrane include a fluorine-based electrolyte membrane such as a thin film of perfluorosulfonic acid containing moisture, a hydrocarbon-based electrolyte membrane, and so forth. Examples of the electrolyte membrane may include a Nafion membrane (manufactured by DuPont), and so forth.

An insulating sheet is disposed between the cathode separator and the anode separator. The insulating sheet may be disposed on the periphery of the membrane electrode gas diffusion layer assembly.

The insulating sheet may have a framework portion, an opening portion, and holes.
The framework portion is a main portion of the insulating sheet that connects to the membrane electrode gas diffusion layer assembly.
The opening portion is a holding region for the membrane electrode gas diffusion layer assembly, and is a region extending through a part of the framework portion in order to house the membrane electrode gas diffusion layer assembly. It is sufficient for the opening portion to be disposed in the insulating sheet at a position where the framework portion is disposed around (in the peripheral portion of) the membrane electrode gas diffusion layer assembly, and may be provided in the middle of the insulating sheet.
The holes in the insulating sheet allow fluids such as reactant gas and coolant to flow in the stacking direction of the unit cell. The holes in the insulating sheet may be disposed positioned so as to communicate with the holes in the separator.
The insulating sheet may include a frame-like form core layer and two frame-like form shell layers provided on both faces of the core layer, i.e., a first shell layer and a second shell layer. The first shell layer and the second shell layer may be provided in a frame-like form on both faces of the core layer, in the same way as with the core layer.

It is sufficient for the core layer to be a structural member having gas sealing properties and insulating properties, and the core layer may be made of a material having a structure that does not change under temperature conditions during thermocompression bonding in a manufacturing process of the fuel cell. Specifically, materials for the core layer include, for example, resin such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyetheretherketone (PEEK), cycloolefin, polyethersulfone (PES), polyphenylsulfone (PPSU), liquid crystal polymer (LCP), epoxy resin, and so forth. The material of the core layer may be a rubber material such as ethylene propylene diene rubber (EPDM), fluororubber, silicone rubber, or the like.

The thickness of the core layer may be 5 μm or more, or may be 20 μm or more, from the viewpoint of ensuring insulation, and may be 200 μm or less, or may be 150 μm or less, from the viewpoint of reducing the cell thickness.

The first shell layer and the second shell layer may have a high adherence property to other materials, have a property of softening under temperature conditions during thermocompression bonding, and have a property of lower viscosity and melting point than the core layer, in order to adhere the core layer with the anode separator and the cathode separator, and ensure sealing performance Specifically, the first shell layer and the second shell layer may be a thermoplastic resin such as a polyester-based thermoplastic resin, a modified olefin-based thermoplastic resin, or the like, or may be a thermosetting resin that is a modified epoxy resin.

The resin that makes up the first shell layer and the resin that makes up the second shell layer may be the same type of resin or may be different types of resin. Providing the shell layers on both faces of the core layer facilitates adhering the insulating sheet and the two separators to each other by hot pressing.
The shell layer thickness of each of the first shell layer and the second shell layer may be 5 μm or more, or may be 30 μm or more, from the viewpoint of ensuring adhesiveness, and may be 100 μm or less, or may be 40 μm or less, from the viewpoint of reducing the cell thickness.

In the insulating sheet, the first shell layer and the second shell layer may be provided only on the portions to be adhered to the anode separator and the cathode separator (sealing region of separator), respectively. The first shell layer provided on one face of the core layer may be adhered to the cathode separator. The second shell layer provided on the other face of the core layer may be adhered to the anode separator. The insulating sheet may be held between a pair of the separators.

The fuel cell stack may have a manifold with which each hole communicates, such as a supply manifold with which each supply hole communicates and a discharge manifold with which each discharge hole communicates, and so forth.

Examples of the supply manifold include a fuel gas supply manifold, an oxidant gas supply manifold, a coolant supply manifold, and so forth.
Examples of the discharge manifold include a fuel gas discharge manifold, an oxidant gas discharge manifold, a coolant discharge manifold, and so forth.
In the present disclosure, the coolant supply manifold and the coolant discharge manifold will be collectively referred to as “coolant manifolds”.

The fuel cell stack may be provided with gaskets between adjacent unit cells. Gaskets are used as sealing members for suppressing leakage of reactant gas from each reactant gas system.

The gaskets may be made of ethylene propylene diene monomer (EPDM) rubber, silicone rubber, thermoplastic elastomer resin, or the like.

A unit cell includes a pair of separators.

The separators hold the insulating sheet, and normally further hold the membrane electrode gas diffusion layer assembly as well.
In the separators, one is an anode separator and the other is a cathode separator. In the present disclosure, the anode separator and the cathode separator will be collectively referred to as “separators”.
The separators may have holes such as a supply hole and a discharge hole, for fluids such as reactant gas and coolant to flow in the stacking direction of the unit cells. Examples of coolant that can be used include a mixed solution of ethylene glycol and water, to suppress freezing at low temperatures.
Examples of the supply hole include a fuel gas supply hole, an oxidant gas supply hole, a coolant supply hole, and so forth.
Examples of the discharge hole include a fuel gas discharge hole, an oxidant gas discharge hole, a coolant discharge hole, and so forth.
For the sake of convenience, these holes may be referred to as “manifolds” in the present disclosure.
The separators may have a reactant gas channel on a face in contact with the gas diffusion layers. The separators may also have a coolant channel, for maintaining a constant temperature of the fuel cell, on a face opposite to the face in contact with the gas diffusion layers.
The anode separator may have a fuel gas channel on the face in contact with the anode-side gas diffusion layer. Also, the anode separator may have a coolant channel for keeping the temperature of the fuel cell constant, on the face opposite to the face in contact with the anode-side gas diffusion layer.
The cathode separator may have an oxidant gas channel on the face in contact with the cathode-side gas diffusion layer. Also, the cathode separator may have a coolant channel for keeping the temperature of the fuel cell constant, on the face opposite to the face in contact with the cathode-side gas diffusion layer.
The separator may be a plate made of stainless steel such as steel-use-stainless.
The shape of the separator may be a rectangle, a laterally-elongated hexagon, a laterally-elongated octagon, a circle, an oblong shape, or the like.

In the present disclosure, the fuel gas and the oxidant gas will be collectively referred to as “reactant gasses”. The reactant gas supplied to the anode is fuel gas, and the reactant gas supplied to the cathode is oxidant gas. The fuel gas is a gas containing primarily hydrogen, and may be hydrogen. The oxidant gas is a gas containing oxygen, and may be oxygen, air, dry air, or the like.

The separator has a coolant lead-in or lead-out region between the coolant supply hole or the coolant discharge hole that make up the coolant manifold, and the coolant channel

Specifically, the separator has a coolant lead-in region between the coolant supply hole making up a coolant supply manifold, and the coolant channel, and has a coolant lead-out region between a coolant discharge hole making up a coolant discharge manifold, and the coolant channel.
The region of the separator adjacent to the coolant manifold (coolant supply hole or coolant discharge hole making up the coolant manifold) of the unit cell in the planar direction has a coolant lead-in or lead-out region and a region other than the coolant lead-in or lead-out region.
Specifically, the region of the separator adjacent to the coolant supply manifold of the unit cell in the planar direction has a coolant lead-in region and a region other than the coolant lead-in region, and the region of the separator adjacent to the coolant discharge manifold of the unit cell in the planar direction has a coolant lead-out region and a region other than the coolant lead-out region.
The region other than the coolant lead-in or lead-out region may be a region of the separator adjacent to the coolant manifold of the unit cell in the planar direction, and may be a region that does not communicate with the coolant channel

### (1) First Embodiment

In at least one unit cell among a plurality of unit cells of a fuel cell stack according to a first embodiment of the present disclosure, at least one separator of a cathode separator and an anode separator has, in a region adjacent to the coolant manifold of the unit cell in the planar direction, a sacrificial electrolytic corrosion region that is not adhered to an insulating sheet adjacent in the laminating direction, and a sealing region that is adjacent to the sacrificial electrolytic corrosion region in the planar direction and is adhered to the insulating sheet.

That is to say, the sacrificial electrolytic corrosion region is a region of the separator that is adjacent to the coolant manifold in the planar direction, and that is not adhered to the insulating sheet.
Also, the sealing region is a region of the separator that is adjacent to the sacrificial electrolytic corrosion region in the planar direction, and that is adhered to the insulating sheet. It is sufficient for the sacrificial electrolytic corrosion region to be provided on at least one separator of the cathode separator and the anode separator, and the sacrificial electrolytic
corrosion region may be provided on both separators. It is sufficient for the sacrificial electrolytic corrosion region to be provided in at least one unit cell among the unit cells, and the sacrificial electrolytic corrosion region may be provided in all of the unit cells.

In the sacrificial electrolytic corrosion region, the shape of the coolant lead-in or lead-out region of the separator is a flat plate shape that is in contact with the insulating sheet.

It is sufficient for the shape of a region other than the coolant lead-in or lead-out region of the separator in the sacrificial electrolytic corrosion region to have an uneven shape of being at least partially out of contact with the insulating sheet, and the region other than the coolant lead-in or lead-out region does not have to be in contact with the insulating sheet at all, provided that the shape is an uneven shape.
In the sacrificial electrolytic corrosion region, the shape of the coolant lead-in region of the separator is a flat plate shape that is in contact with the insulating sheet, and the shape of the region other than the coolant lead-in region in the sacrificial electrolytic corrosion region may be an uneven shape that is at least partially out of contact with the insulating sheet.
In the sacrificial electrolytic corrosion region, the shape of the coolant lead-out region of the separator is a flat plate shape that is in contact with the insulating sheet, and the shape of the region other than the coolant lead-out region in the sacrificial electrolytic corrosion region may be an uneven shape that is at least partially out of contact with the insulating sheet.

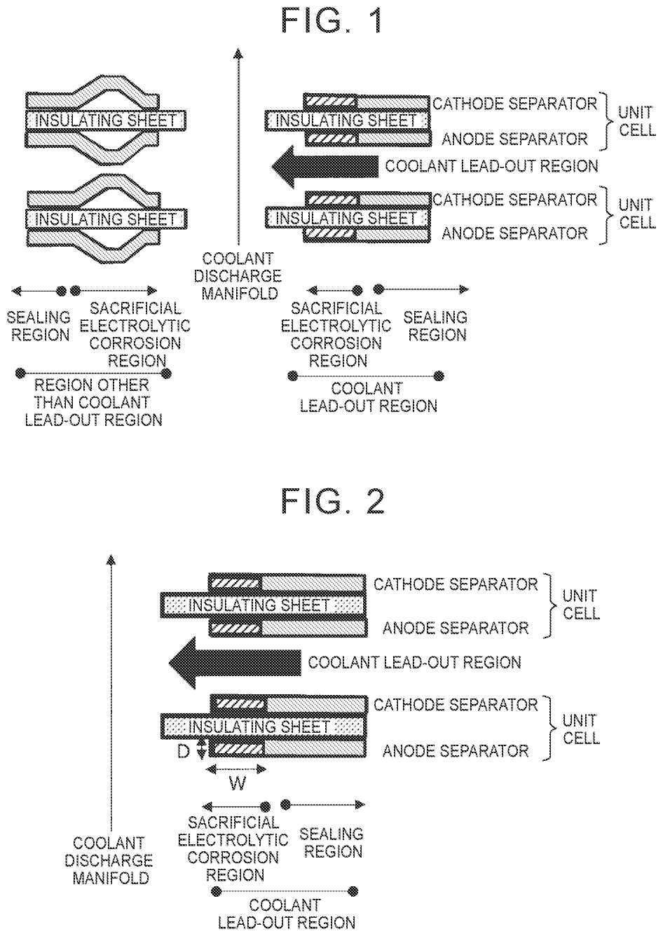

FIG. 1 is a schematic cross-sectional view illustrating an example of a vicinity of a coolant discharge manifold of a fuel cell stack according to the first embodiment of the present disclosure.

As illustrated in FIG. 1, in each unit cell of a fuel cell stack according to the first embodiment of the present disclosure, the cathode separator and the anode separator have, in a region adjacent to the coolant discharge manifold of the unit cell in the planar direction, a sacrificial electrolytic corrosion region that is not adhered to the insulating sheet adjacent in the laminating direction, and a sealing region that is adjacent to the sacrificial electrolytic corrosion region in the planar direction and is adhered to the insulating sheet. In the sacrificial electrolytic corrosion region, the shape of the coolant lead-out region of the separator is a flat plate shape that is in contact with the insulating sheet, and the shape of the region other than the coolant lead-out region in the sacrificial electrolytic corrosion region is an uneven shape that is partially out of contact with the insulating sheet.
Note that in FIG. 1, an example of a coolant discharge manifold is illustrated as the coolant manifold, but the same configuration as the coolant discharge manifold can be used when the coolant manifold is a coolant supply manifold, as well.

### (2) Second Embodiment

In a fuel cell stack according to a second embodiment of the present disclosure, when a width in the planar direction from an end portion of the coolant manifold on the coolant inlet or outlet side of the sacrificial electrolytic corrosion region is defined as a sacrificial electrolytic corrosion distance W (mm), a sacrificial electrolytic corrosion surface area W x D, which is the product of the sacrificial electrolytic corrosion distance W (mm) and the thickness D (mm) of the separator, may be 0.25 mm² or more, and from the perspective of balance between the build (energy density) of the fuel cell stack and life thereof, the upper limit may be 1.00 mm² or less.

The sacrificial electrolytic corrosion distance W (mm) may be 2.1 mm to 13 mm, the lower limit may be 2.5 mm or more, or 3 mm or more, and the upper limit may be 6 mm or less, or may be 4 mm or less.
The thickness D (mm) of the separator may be 0.08 mm to 0.12 mm, and the lower limit may be 0.1 mm or more.
The ionic conductivity of the separator is not limited in particular, and may be 1 μS/cm² to 8 μS/cm², and may be 2 μS/cm² to 6 μS/cm².
The end portion of the sacrificial electrolytic corrosion region on the coolant inlet or outlet side of the coolant manifold may be the end portion of the coolant lead-in or lead-out region of the separator on the coolant manifold side.
The end portion of the sacrificial electrolytic corrosion region on the coolant inlet side of the coolant supply manifold may be the end portion of the coolant lead-in region of the separator on the coolant supply manifold side.
The end portion of the sacrificial electrolytic corrosion region on the coolant outlet side of the coolant discharge manifold may be the end portion of the coolant lead-out region of the separator on the coolant discharge manifold side.

FIG. 2 is a schematic cross-sectional view illustrating an example for describing a sacrificial electrolytic corrosion distance W and a separator thickness D of the fuel cell stack according to the second embodiment of the present disclosure, in the vicinity of the coolant discharge manifold.

Note that in FIG. 2, an example of a coolant discharge manifold is illustrated as the coolant manifold, but the same configuration as the coolant discharge manifold can be used when the coolant manifold is a coolant supply manifold, as well.

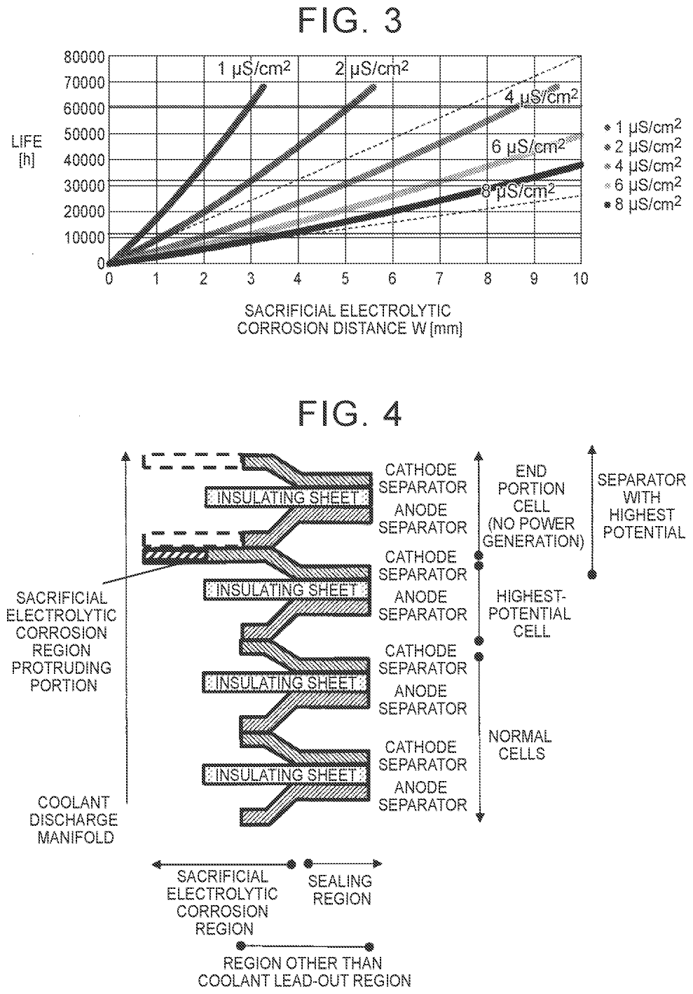

FIG. 3 is a graph showing an example of a relation between the sacrificial electrolytic corrosion distance W of separators having different ionic conductivities in the fuel cell stack according to the second embodiment, and the life of the fuel cell stack.

The life of the fuel cell stack may be estimated taking into consideration empirical rules based on relations among, for example, a sacrificial electrolytic corrosion volume V (mm³) of the separator, an electrolytic corrosion rate S (mol/s) of the separator, and the ionic conductivity (μS/cm²) of the separator.
In the present disclosure, the sacrificial electrolytic corrosion volume V (mm³) of the separator is D×W×L, which is the product of the thickness D (mm) of the separator, the sacrificial electrolytic corrosion distance W (mm) that is the width in the planar direction of the coolant manifold from the end portion of the coolant inlet or outlet, and a coolant manifold peripheral length L (mm).
In the present disclosure, the electrolytic corrosion rate S (mol/s) of the separator is L×d×v, which is the product of the coolant manifold peripheral length L (mm), an electrolytic corrosion reaction region length d (mm) of the separator, and a reaction rate v per unit surface area (mol/s·mm²).

According to the second embodiment of the present disclosure, electrolytic corrosion of the separator in the coolant manifold is limited to sacrificial electrolytic corrosion regions. Accordingly, even after the separator is dissolved in the sacrificial electrolytic corrosion region, the sealing structure of the unit cell is not compromised, the sealing function of the unit cell can be preserved, and the life of the fuel cell stack can be extended.

Also, setting the sacrificial electrolytic corrosion surface area to a predetermined value or less enables improvement in the balance between the life of the fuel cell stack and the energy density.

### (3) Third Embodiment

In a fuel cell stack according to a third embodiment of the present disclosure, at least one type of separator selected from a group consisting of a cathode separator of a highest-potential unit cell that contributes to power generation among a plurality of unit cells and has the highest electrical potential, a cathode separator of an end portion unit cell that is adjacent to the highest-potential unit cell and does not contribute to power generation, and an anode separator of the end portion unit cell, may have a sacrificial electrolytic corrosion region protruding portion that protrudes further in a planar direction toward a partial region of the coolant manifold than an insulating sheet adjacent to the separator.

In the fuel cell stack according to the third embodiment, at least a cathode separator of a highest-potential unit cell may have a sacrificial electrolytic corrosion region protruding portion, and further, a cathode separator of an end portion unit cell that is adjacent to the highest-potential unit cell and does not contribute to power generation, and an anode separator of the end portion unit cell may have a sacrificial electrolytic corrosion region protruding portion.
The sacrificial electrolytic corrosion region protruding portion may protrude in a planar direction further toward a partial region of the coolant supply manifold than the insulating sheet, may protrude in the planar direction toward a partial region of the coolant discharge manifold, and may protrude in a planar direction toward a partial region of the coolant supply manifold and the coolant discharge manifold.
It is sufficient for the sacrificial electrolytic corrosion region protruding portion to protrude further toward a partial region of the coolant manifold in the planar direction than the insulating sheet, and may protrude so as not to block the coolant manifold.

FIG. 4 is a schematic cross-sectional view illustrating an example of a vicinity of a coolant discharge manifold of a fuel cell stack according to a third embodiment of the present disclosure.

As illustrated in FIG. 4, in the fuel cell stack of the third embodiment of the present disclosure, a cathode separator of a highest-potential unit cell that contributes to power generation among the unit cells and has the highest electrical potential has a sacrificial electrolytic corrosion region protruding portion that protrudes further in a planar direction toward a partial region of the coolant discharge manifold than an insulating sheet adjacent to the cathode separator.
Note that in FIG. 4, an example of a coolant discharge manifold is illustrated as the coolant manifold, but the same configuration as the coolant discharge manifold can be used when the coolant manifold is a coolant supply manifold, as well.

In the third embodiment of the present disclosure, among the separators of the stacked power generation cells, the separator protrude further toward the coolant manifold side than the insulating sheet adjacent, only at the cathode separator, which has the highest potential and is closest to the negative side, or at the separator of the end portion cell adjacent thereto.

Thus, the separator is subjected to electrolytic corrosion from the protruding edge portion of the separator, thereby protecting other members.
In addition, one to three separators protrude further from the insulating sheet, and accordingly there is no concern of contact with other separators having different potentials, leading to dielectric breakdown.

What is claimed is:

1. A fuel cell stack comprising a cell stack in which multiple unit cells are stacked together, each of the unit cells including a separator made of stainless steel, wherein:
the unit cell includes a cathode separator, an anode separator, and an insulating sheet disposed between the cathode separator and the anode separator;
in at least one unit cell among the unit cells, at least one separator out of the cathode separator and the anode separator includes, in a region adjacent to a coolant manifold of the unit cell in a planar direction, a sacrificial electrolytic corrosion region that is not adhered to the insulating sheet adjacent in a laminating direction, and a sealing region that is adjacent to the sacrificial electrolytic corrosion region in the planar direction and is adhered to the insulating sheet;
the sacrificial electrolytic corrosion region includes a coolant lead-in or lead-out region and a region other than the coolant lead-in or lead-out region;
a shape of the separator in the coolant lead-in or lead-out region is a flat plate shape that is in contact with the insulating sheet; and
a shape of the separator in the region other than the coolant lead-in or lead-out region is an uneven shape that is at least partially out of contact with the insulating sheet.

2. The fuel cell stack according to claim 1, wherein, when a width of the sacrificial electrolytic corrosion region in the planar direction, from an end portion of the coolant manifold on a coolant inlet or outlet side, is defined as a sacrificial electrolytic corrosion distance W, a sacrificial electrolytic corrosion surface area W×D that is a product of the sacrificial electrolytic corrosion distance W and a thickness D of the separator, is 0.25 mm² or more.

3. The fuel cell stack according to claim 1, wherein at least one type of separator includes a sacrificial electrolytic corrosion region protruding portion that protrudes further in the planar direction toward a partial region of the coolant manifold than the insulating sheet adjacent to the separator, the type of separator being selected from a group consisting of: a cathode separator of a highest-potential unit cell that contributes to power generation and has a highest electrical potential among the unit cells, a cathode separator of an end portion unit cell that is adjacent to the highest-potential unit cell and does not contribute to power generation, and an anode separator of the end portion unit cell.

4. The fuel cell stack according to claim 3, wherein the cathode separator of the highest-potential unit cell includes the sacrificial electrolytic corrosion region protruding portion.

5. The fuel cell stack according to claim 2, wherein:
the sacrificial electrolytic corrosion distance W is 2.1 mm to 13 mm; and
the thickness D of the separator is 0.08 mm to 0.12 mm.
